(19) United States
(12) Patent Application Publication
(10) Pub. No.: US 2002/0078089 A1
(43) Pub. Date: Jun. 20, 2002

(54) Automatic bookmarking of web documents at receiving display stations of the world wide web based upon repetitive accessing of the documents

(76) Inventors: Steven Allen Bade, Georgetown, TX (US); Mark-David Joseph McLaughlin, Austin, TX (US)

Correspondence Address: Volel Emile, International Business Machines Corporation, Intellectual Property Law Department, 11400 Burnet Road, Internal Zip 4054, Austin, TX, 78758, US

(21) Appl. No.: 09/737,043

(22) Filed: Dec. 14, 2000

(51) Int. Cl. G06F 17/00

(52) U.S. Cl. 707/513

(57) ABSTRACT

A system, method and program to help a user retrieve previously accessed documents are retroactively determined to be of interest. The bookmarking process associated with a receiving display station for the selection of received documents to thereby store at said receiving display station, direct links to such documents for future access are modified so that they include the following: a combination of an implementation at the receiving display station for tracking the number of times each document is received and a function responsive to these tracking means for bookmarking a received document after said document has been received a predetermined number of times at the receiving display station. A process may be optionally included for permitting a user at said receiving display station to change said predetermined number of times. These optional means may conveniently be implemented by a routine for displaying to said user that the document has been received for said predetermined number of times, combined with a function enabling the user to bookmark the document. In this implementation, a function may be provided enabling a user at said receiving display station to change said predetermined number of times for a received document even after the document has been received for said predetermined number of times. Of course, the system may be set up so that the received document is automatically bookmarked after the document has been received at said receiving display station for said predetermined number of times without providing the user with the above option.

### TECHNICAL FIELD

The present invention relates to computer managed communication networks, such as the World Wide Web (Web), and particularly to ease of use of interactive computer controlled display interfaces to such networks for substantially reducing the time and resources required to access Web documents from the Web.

### BACKGROUND OF RELATED ART

The 1990's decade has been marked by a technological revolution driven by the convergence of the data processing industry with the consumer electronics industry. The effect has, in turn, driven technologies which have been known and available but relatively quiescent over the years. A major one of these technologies is the Internet related distribution of documents, media and programs. The convergence of the electronic entertainment and consumer industries with data processing exponentially accelerated the demand for wide ranging communications distribution channels and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct links between pages and other documentation on the Web and a variety of related data sources which were at first text and then evolved into media, i.e. “hypermedia”. This even further exploded the use of the Internet or Web. It was now possible for the Web browser or wanderer to spend literally hours going through document after document and accompanying media events in often less than productive excursions through the Web. These excursions often strained the user's time and resources. In order for the Internet to mature from its great expectations to solid commercial fruition, it will be necessary for the Internet to greatly reduce its drain on time and related resources. A significant source of this drain is in the Web page, the basic document page of the Web. Web pages still do not have much in the way of interface standards. Although many Web pages are professionally designed and, thus, relatively efficient to use, there are still a great many Web pages which are very cumbersome to access and to use, particularly when the user is making in depth searches.

The Web browsers, which have been available for over a decade as a Web document search and access tool, have provided users with the means of bookmarking and thereby saving Web documents. However, because of the size and cumbersome format of many Web documents, users are often reluctant to initially bookmark documents. At some point when users do retroactively recognize the importance of a particular Web document, they must consume time and effort backtracking through their Web browsing activities in order to retrieve the documents of interest. The Web browsing technology has been seeking developments to make retroactive retrieval of Web documents less cumbersome. The present invention offers an implementation toward this end.

### SUMMARY OF THE PRESENT INVENTION

The present invention provides a system, method and program to help a user retrieve previously accessed documents which are retroactively determined to be of interest. The bookmarking means associated with a receiving display station for the selection of received documents to thereby store at said receiving display station direct links to such documents for future access are modified so that they include the following: a combination of means at the receiving display station for tracking the number of times each document is received; and means responsive to these tracking means for bookmarking a received document after said document has been received a predetermined number of times at the receiving display station. Means may be optionally included for permitting a user at said receiving display station to change said predetermined number of times. These optional means may conveniently be implemented by means for displaying to said user that the document has been received for said predetermined number of times, combined with means enabling the user to bookmark the document. In this implementation, means may be provided for enabling a user at said receiving display station to change said predetermined number of times for a received document even after the document has been received for said predetermined number of times. Of course, the system may be set up so that the received document is automatically bookmarked after the document has been received at said receiving display station for said predetermined number of times without providing the user with the above option. The Web browsing means at the receiving display station is preferably set up to include the means for bookmarking of selected received documents, the means for tracking the number of times each document is received at said receiving display station and the means responsive to said tracking means for bookmarking a received document after said document has been received a predetermined number of times at the receiving display station.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter which is capable of implementing the receiving display station on which the received Web page or Web document may be processed by bookmarking in accordance with the present invention;

FIG. 2 is a generalized diagrammatic view of a World Wide Web portion upon which the present invention may be implemented;

FIG. 3 is a diagrammatic illustration of a display screen showing an initial World Wide Web page which may be automatically bookmarked in accordance with the present invention;

FIG. 4 is the display screen of FIG. 3 showing the dialog box through which the user may change the settings for the number of times that any World Wide Web document must be received before it is automatically bookmarked;

FIG. 5 is a display screen like that of FIG. 3 illustrating the operation of giving the user the option of changing the document “hit” number before the World Wide Web document is bookmarked;

FIG. 6 is a general flowchart of a program set up to implement the present invention for the automatic bookmarking of World Wide Web pages; and

FIG. 7 is a flowchart of an illustrative run of the program set up in FIG. 6.

### DETAILED DESCRIPTION OF THE PREFERRED EMBODIMENT

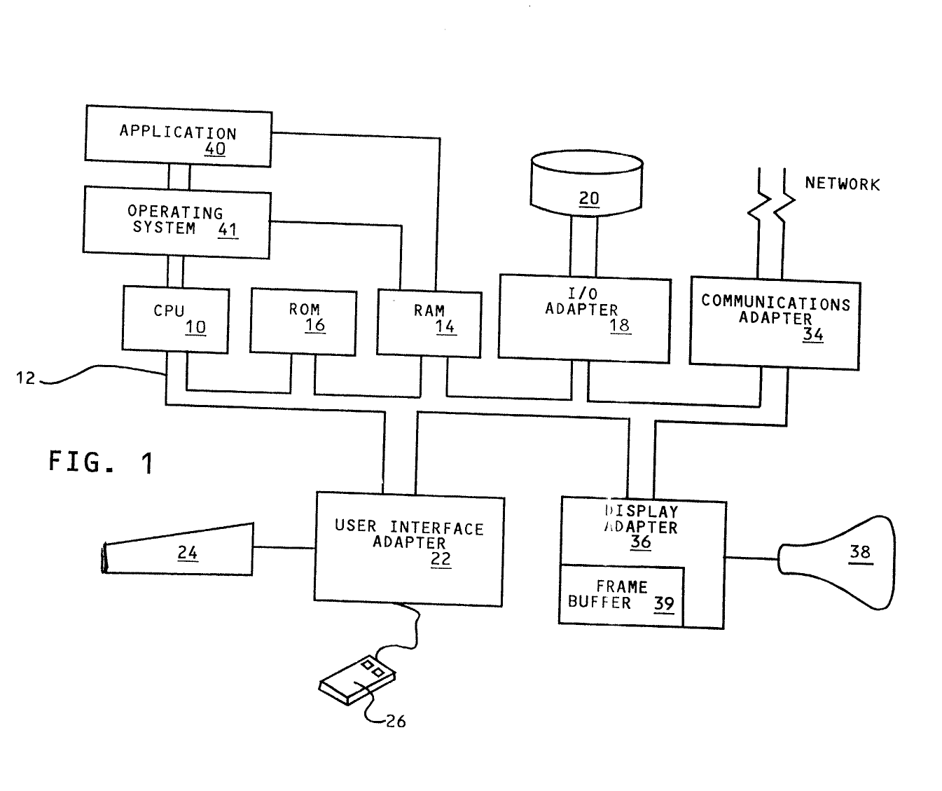

Referring to FIG. 1, a typical data processing terminal is shown which may function as a basic computer implementing the present invention for the automatic bookmarking of received Web documents after such documents have been received a predetermined number of times. A central processing unit (CPU) 10, such as one of the PC microprocessors or workstations, e.g. RISC System 6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems such as IBM's AIX 6000™ operating system or Microsoft's Windows98™ or WindowsNT™ , as well as UNIX and other AIX operating systems. Application programs 40, controlled by the system, are moved into and out of the main memory Random Access Memory (RAM) 14. These programs include the program of the present invention to be subsequently described in combination with any conventional Web browser, such as the Netscape 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over a Local Area Network (LAN) or Wide Area Network (WAN), which includes, of course, the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for bookmarking according to the present invention. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods which may be related to the present invention. Since a major aspect of the present invention is directed to documents, such as Web pages, transmitted over networks, an understanding of networks and their operating principles would be helpful. We will not go into great detail in describing the networks to which the present invention is applicable. Reference has also been made to the applicability of the present invention to a global network such as the Internet. For details on Internet nodes, objects and links, reference is made to the text, Mastering the Internet, G. H. Cady et al., published by Sybex Inc., Alameda, Calif., 1996.

Any data communication system which interconnects or links computer controlled systems with various sites defines a communications network. A network may be as simple as two linked computers or it may be any combination of LANs or WANs. Of course, the Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term documents as used to describe data transmitted over the Web or other networks is intended to include Web pages including displayable text, graphics and other images. This displayable information may be still, in motion or animated, e.g. animated GIF images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages. In addition, aspects of this invention will involve Web browsers. A general and comprehensive description of browsers may be found in the above-mentioned Mastering the Internet text at pp. 291-313. Also, in the description which follows, reference will be made to searching and search engines.

Web searching is done through selected search engines, resident on the Web or Internet access servers. Typical search engines include Yahoo, AltaVista, Infoseek and Lycos engines. Such search engines are described in greater detail in the above-mentioned text, Mastering the Internet, at pp. 347-357.

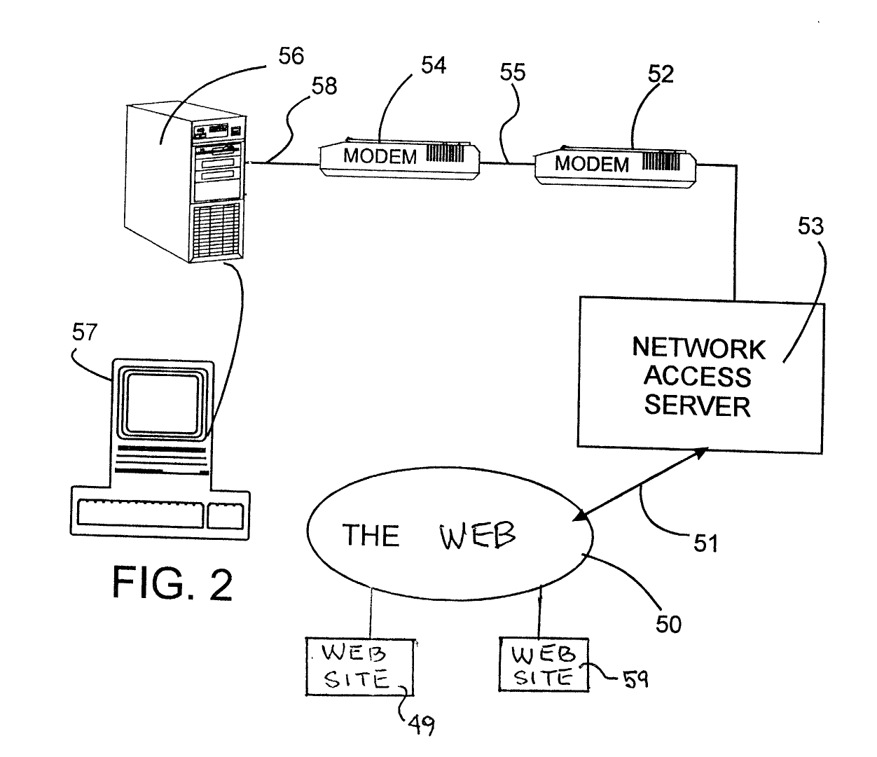

A generalized diagram of a portion of the Internet, which the computer 56 controlled display terminal 57 used for Web page or other document display of the present invention, is connected as shown in FIG. 2. Computer 56 and display terminal 57 are the computer system shown in FIG. 1 and connection 58 (FIG. 2) is the network connection shown in FIG. 1. Reference may be made to the above-mentioned Mastering the Internet, pp. 136-147, for typical connections between local display workstations to the Internet via network servers, any of which may be used to implement the system on which this invention is used. The system embodiment of FIG. 2 is one of these known as a host-dial connection. Such host-dial connections have been in use for over 30 years through network access servers 53 which are linked 51 to the Web 50. The servers 53 are maintained by a service provider to the client's display terminal 57. The host's server 53 is accessed by the client terminal 57 through a normal dial-up telephone linkage 58 via modem 54, telephone line 55 and modem 52. The HTML files representative of the Web pages are downloaded to display terminal 57 through controlling server 53 and computer 56 via the telephone line linkages from server 53 which may have accessed them from the Web 50 via linkage 51. The various Web documents are transmitted from a variety of Web sites, e.g. sites 49 and 59.

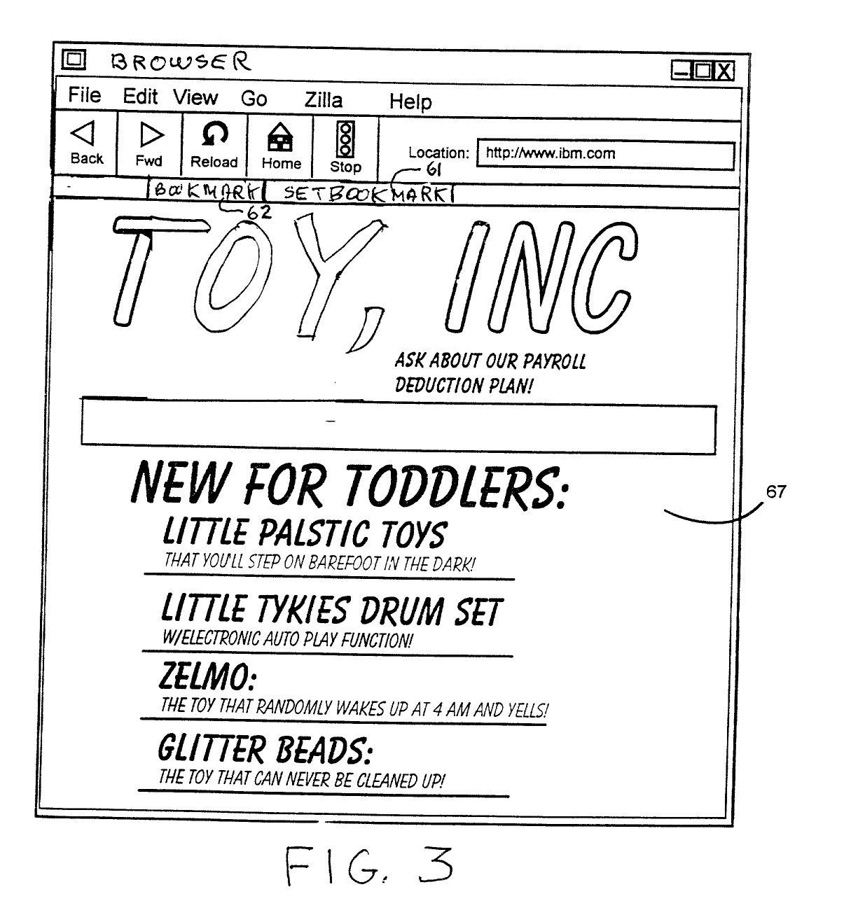

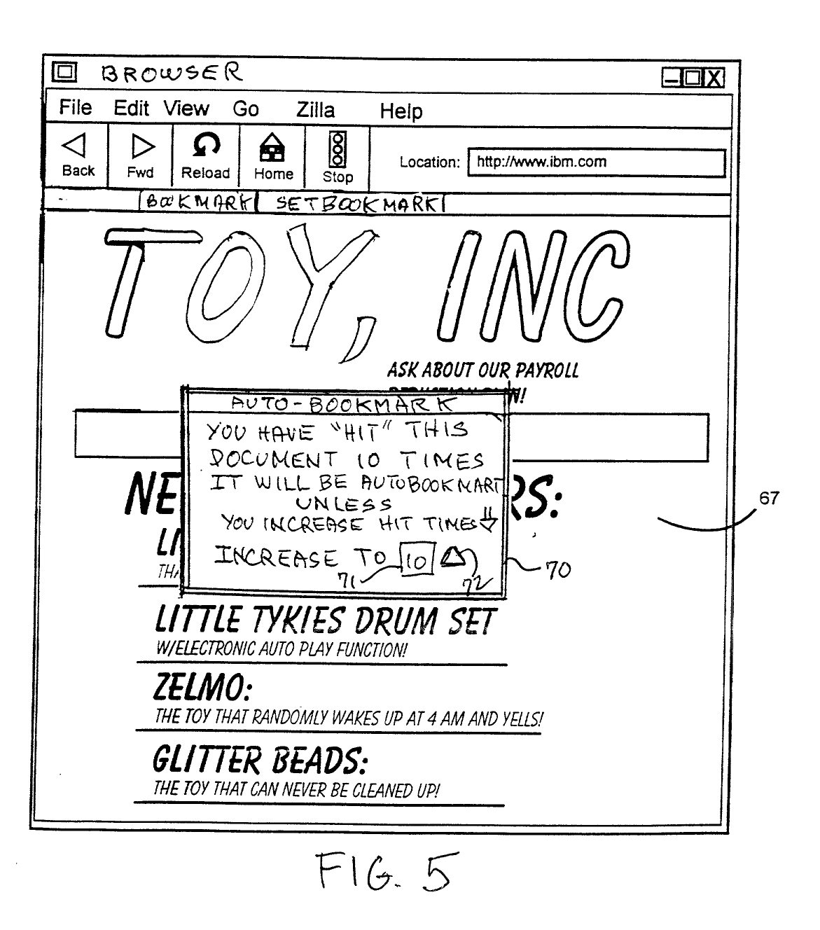

Now with respect to FIGS. 3 through 5, we will provide an illustrative example of how the present invention may be used to provide automatic bookmarking of Web documents after such documents have been received or “hit” by a receiving Web station a selected number of times. When the screen images are described, it will be understood that these may be rendered by storing image and text creation programs, such as those in any conventional window operating system and in a standard browser program in the RAM 14 of the system of FIG. 1. The operating system is diagrammatically shown in FIG. 1 as operating system 41. The display screens of FIG. 5 are presented to the viewer on display monitor 38 of FIG. 1. In accordance with conventional techniques, the user may control the screen interactively through a conventional I/O device, such as mouse 26, FIG. 1, which operates through user interface 22 to call upon programs in RAM 14 cooperating with the operating system 41 to create the images in frame buffer 39 of display adapter 36 to control the display on monitor 38.

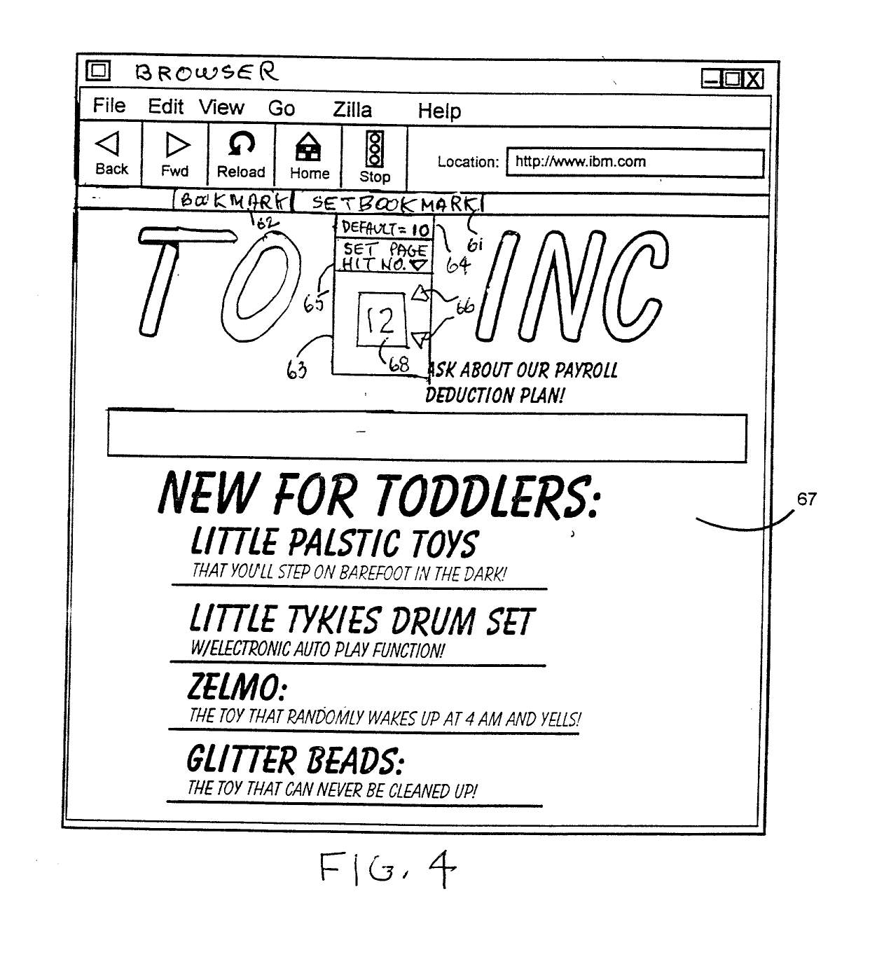

Also with respect to FIG. 3, we will describe an illustrative simple display screen browser interface which may be used to implement the browser program modifications of the present invention. There is shown Web page 67, a simple Web document received from the Web at a receiving Web station. In addition to the standard bookmark item 62 on the menu line, there is an item, “Set Bookmark” 61, for setting the automatic bookmarking. When item 61 is interactively selected by the user, we get the display screen of FIG. 4 wherein dialog box 63 comes down. Item 64 presents the default number of “hits” for an incoming Web document upon which the document will be bookmarked. The user is presented with an element 65 for changing this default number. Buttons 66 change the new number 68 up or down. Whatever the selected hit number, when it is reached, the document is automatically bookmarked. The Web browser keeps track of the source addresses of all received Web documents. This may be used to count the number of times that particular Web documents have been hit or received.

In an alternative optional version shown in FIG. 5, the document is not automatically bookmarked when the selected hit is reached. Rather, a user interactive dialog box 70 comes up. The user is advised that the predetermined hit number has been reached, and the user is given the opportunity via control button 72 to change the predetermined hit number 71 if he does not wish to bookmark the document as yet. At this point, this number can only be raised. Subsequently, if the new number of hits is reached, the document will be automatically bookmarked. It should be noted that the count of hits for documents may be tracked until cleared or reset by the user. The count can be tracked only during a Web browsing session or series of sessions.

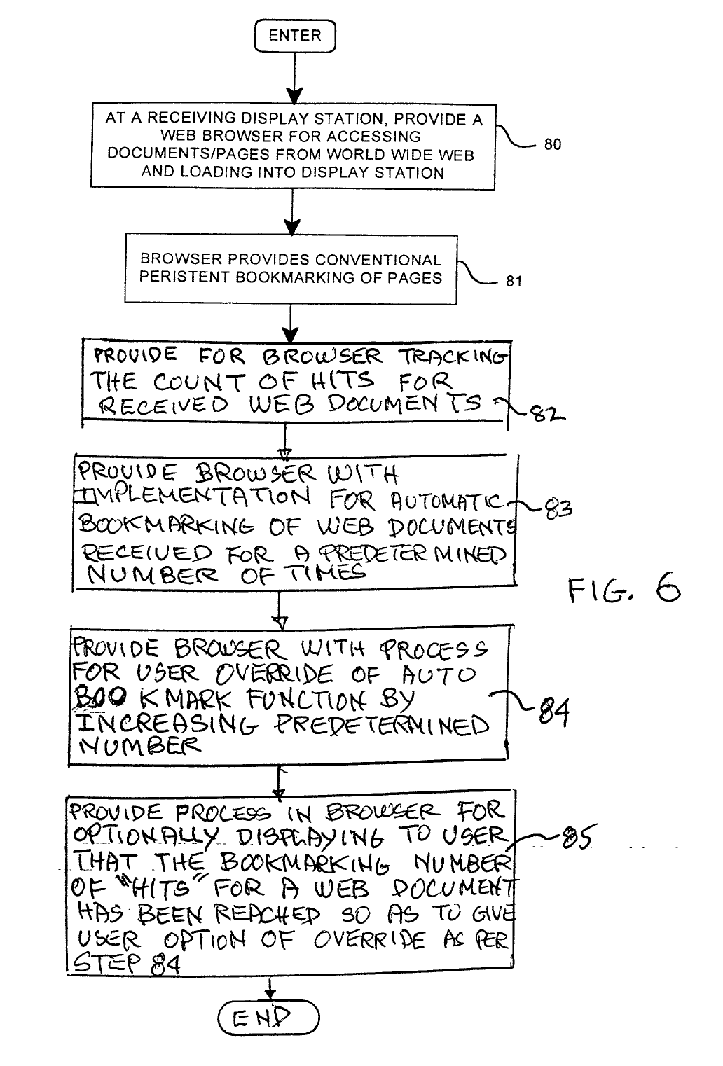

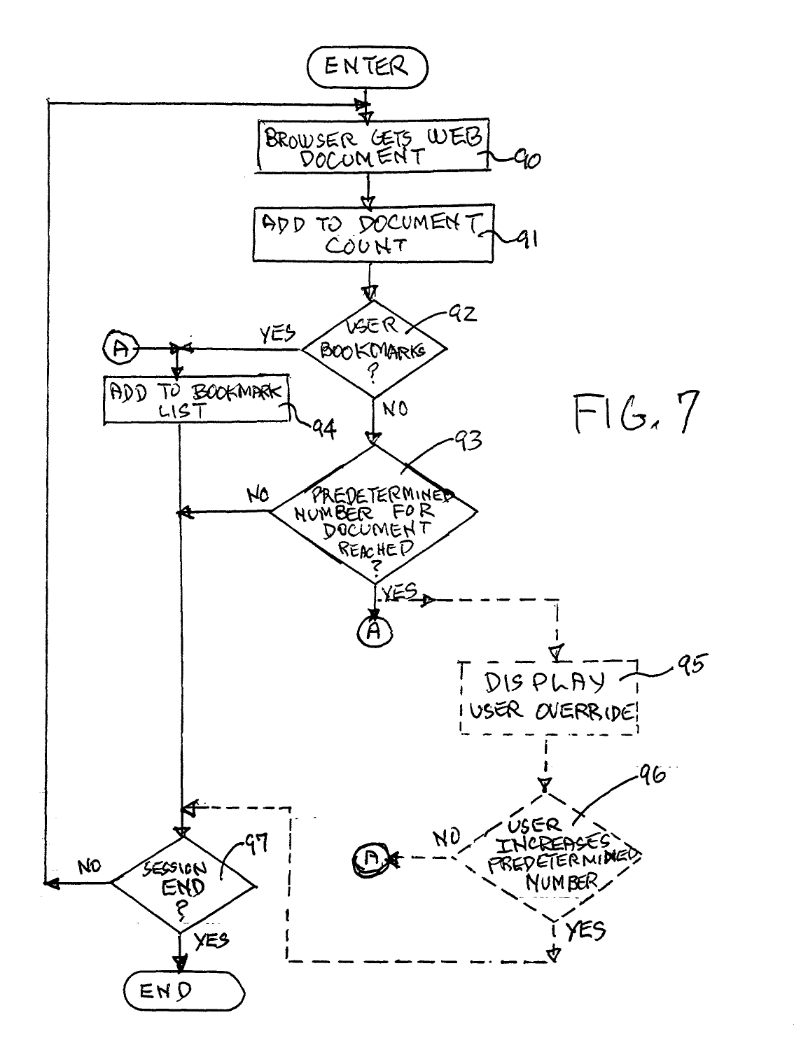

Now, with reference to FIGS. 6 and 7 we will describe a process implemented by the present invention in conjunction with the flowcharts of these figures. FIG. 6 is a flowchart showing the development of a process according to the present invention for enabling a user searching the Web to assign automatic bookmarks to a variety of received documents. With reference to FIG. 6, first, process step 80, a conventional Web browser program is provided at the Web page receiving display station, e.g. the computer controlled display of FIG. 1 or display station 56, 57 of FIG. 2. The Web browser provides for the bookmarking of Web pages in the conventional manner, step 81. A program routine is provided at the receiving display station, preferably in the browser, for automatically bookmarking received Web documents which includes the steps of providing the browser with a facility for tracking the count of hits for each received Web document, step 82.

The browser is provided with an implementation for automatic bookmarking of Web documents received for a predetermined number of times, step 83. The browser is also provided with a process for the overriding of an automatic bookmarking function by increasing the predetermined number, step 84. This may be optionally implemented by displaying to the user that the bookmarking number of hits for a received Web document has been reached so as to give the user the override function as illustrated in FIG. 5.

The running of the process will now be described with respect to FIG. 7. First, step 90, when there is a received Web document, the browser program loads the document into the receiving computer display. The browser adds one to the count for that document. Then a determination is made as to whether the user has pressed the standard bookmark button, decision step 92. If Yes, then, step 94, a conventional bookmark is set up, listed and the linkage to the bookmarked document is stored. If the decision in step 92 is No, the process moves to step 93 where a determination is made as to whether the predetermined number of hits for the particular document has been reached. If Yes, the process automatically branches to step 94, where a bookmark is set up, listed and the linkage to the bookmarked document is stored. There is an alternative to this automatic bookmarking upon a Yes decision from step 93, as shown by the dotted lines, the override option dialog box of FIG. 5 may be displayed to the user, step 95, and a determination is made as to whether the user wishes to override the automatic bookmarking by increasing the predetermined number of required document hits, step 96. If No, then, like the automatic branching, the process branches to step 94, where a bookmark is set up, listed and the linkage to the bookmarked document is stored. If the decision from step 96 is Yes, the document is not bookmarked and the predetermined hit number is increased and stored. At this point, as well as after step 94 and after a No decision from step 93, a determination may be conveniently made as to whether a session is over, step 97. If No, the process is returned to step 90 where the processing of the next Web document will be commenced. If the decision from step 97 is Yes, the session is ended, then the session is exited but the count of received Web documents may still be stored in connection with the browser program over several browsing sessions.

One of the preferred implementations of the present invention is as a routine in an operating system made up of programming steps or instructions resident in RAM 14, FIG. 1, during computer operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Although certain preferred embodiments have been shown and described, it will be understood that many changes and modifications may be made therein without departing from the scope and intent of the appended claims.

What is claimed is:

1. In a World Wide Web (Web) communication network with user access via a plurality of data processor controlled interactive receiving display stations for displaying received hypertext documents of at least one display page containing text, images and a plurality of embedded hyperlinks to hypertext documents accessible from sources on the Web, a system for bookmarking of selected transmitted documents comprising:
means associated with one of said receiving display stations for bookmarking of selected received documents to thereby store at said receiving display station, direct links to the documents for future access;
means at the receiving display station for tracking the number of times each document is received at said receiving display station; and
means responsive to said tracking means for bookmarking a received document after said document has been received a predetermined number of times at the receiving display station.

2. The system of claim 1 further including means permitting a user at said receiving display station to change said predetermined number of times.

3. The system of claim 1 wherein said means for bookmarking said document received for said predetermined number of times includes:
means for displaying to said user that the document has been received for said predetermined number of times; and
means enabling the user to bookmark the document.

4. The system of claim 3 further including means enabling a user at said receiving display station to change said predetermined number of times for a received document even after the document has been received for said predetermined number of times.

5. The system of claim 1 wherein said received document is automatically bookmarked after the document has been received at said receiving display station for said predetermined number of times.

6. The network system of claim 1 further comprising:
Web browsing means at said receiving display station including:
said means for bookmarking of selected received documents;
said means for tracking the number of times each document is received at said receiving display station; and
said means responsive to said tracking means for bookmarking a received document after said document has been received a predetermined number of times at the receiving display station.

7. In a Web communication network with user access via a plurality of data processor controlled interactive receiving display stations for displaying received hypertext documents of at least one display page containing text, images and a plurality of embedded hyperlinks to hypertext documents accessible from sources on the Web, method for bookmarking of selected transmitted documents comprising:
enabling the bookmarking of selected documents received at one of the receiving display stations to thereby store at said receiving display station, direct links to the documents for future access;
tracking the number of times each document is received at said receiving display station; and
bookmarking a received document after said document has been received a predetermined number of times at the receiving display station.

8. The method of claim 7 further including the step of permitting a user at said receiving display station to change said predetermined number of times.

9. The method of claim 7 wherein said step of bookmarking said document received for said predetermined number of times includes:
displaying to said user that the document has been received for said predetermined number of times; and
enabling the user to bookmark the document.

10. The method of claim 9 further including the step of enabling a user at said receiving display station to change said predetermined number of times for a received document even after the document has been received for said predetermined number of times.

11. The method of claim 7 wherein said received document is automatically bookmarked after the document has been received at said receiving display station for said predetermined number of times.

12. The method of claim 7 further comprising:
a Web browsing process at said receiving display station including said steps of:
bookmarking of selected transmitted documents;
tracking the number of times each document is received at said receiving display station; and
said bookmarking a received document after said document has been received a predetermined number of times at the receiving display station.

13. A computer program having code recorded on a computer readable medium for bookmarking of selected transmitted documents in a Web communication network with user access via a plurality of data processor controlled interactive receiving display stations for displaying received hypertext documents of at least one display page containing text, images and a plurality of embedded hyperlinks to hypertext documents accessible from sources on the Web, said program comprising:
means associated with one of said receiving display stations for bookmarking of selected received documents to thereby store at said receiving display station, direct links to the documents for future access;
means at the receiving display station for tracking the number of times each document is received at said receiving display station; and
means responsive to said tracking means for bookmarking a received document after said document has been received a predetermined number of times at the receiving display station.

14. The computer program of claim 13 further including means permitting a user at said receiving display station to change said predetermined number of times.

15. The computer program of claim 13 wherein said means for bookmarking said document received for said predetermined number of times includes:
means for displaying to said user that the document has been received for said predetermined number of times; and
means enabling the user to bookmark the document.

16. The computer program of claim 15 further including means enabling a user at said receiving display station to change said predetermined number of times for a received document even after the document has been received for said predetermined number of times.

17. The computer program of claim 13 wherein said received document is automatically bookmarked after the document has been received at said receiving display station for said predetermined number of times.

18. The computer program of claim 13 further comprising:
a Web browser program at said receiving display station including:
said means for bookmarking of selected received documents;
said means for tracking the number of times each document is received at said receiving display station; and
said means responsive to said tracking means for bookmarking a received document after said document has been received a predetermined number of times at the receiving display station.
